(19) United States
(12) Patent Application Publication
(10) Pub. No.: US 2026/0321631 A1
(43) Pub. Date: Oct. 15, 2026

(54) POSITIVE ELECTRODE ACTIVE MATERIAL, PREPARATION METHOD THEREFOR, SODIUM ION BATTERY, AND ELECTRICAL DEVICE

(71) Applicant: BYD COMPANY LIMITED, Shenzhen (CN)

(72) Inventors: Xiaoqiang YIN, Shenzhen (CN); Yadong ZHANG, Shenzhen (CN); Lina JIN, Shenzhen (CN); Xiangyu LI, Shenzhen (CN)

(73) Assignee: BYD COMPANY LIMITED, Shenzhen (CN)

(21) Appl. No.: 19/691,370

(22) Filed: May 28, 2026

Related U.S. Application Data
(63) Continuation of application No. PCT/CN2024/117578, filed on Sep. 6, 2024.

(30) Foreign Application Priority Data
Nov. 30, 2023 (CN) 202311638513.0

(51) Int. Cl. H01M 4/58; C01B 25/37; H01M 4/02; H01M 10/054

(52) U.S. Cl. CPC H01M 4/5825; C01B 25/375; H01M 10/054; C01P 2002/72; C01P 2006/40; H01M 2004/028

(57) ABSTRACT

A positive electrode active material has the following general formula: NaₓM_{y}(P_{1 w}A_{w}O₄)_{z}(P₂₋ᵤAᵤO₇). M is selected from one or more of Fe, Ti, V, Cr, Mn, Mg, Ca, Zr, Cd, Co, Ni, Cu, Zn and Nb. A is selected from one or more of Ga, Ge, Sb, Se, Te, Bi and In. x satisfies a condition of 2≤x≤4; y satisfies a condition of 1≤y≤4; z satisfies a condition of 0≤z≤2; w satisfies a condition of 0<w≤0.25; u satisfies a condition of 0≤u≤0.2; and u and z are not 0 at the same time.

### CROSS-REFERENCE TO RELATED APPLICATIONS

This application is a continuation of International Application No. PCT/CN2024/117578, filed on Sep. 6, 2024, which claims priority to Chinese Patent Application No. 202311638513.0, filed on Nov. 30, 2023, and entitled “POSITIVE ELECTRODE ACTIVE MATERIAL AND PREPARATION METHOD THEREFOR, SODIUM ION BATTERY, AND ELECTRICAL DEVICE.” The entire disclosures of the prior applications are hereby incorporated by reference.

### TECHNICAL FIELD

The present disclosure relates to the field of positive electrode active materials for sodium ion batteries, including a positive electrode active material, a method of making a positive electrode active material, a sodium ion battery, and an electrical device.

### BACKGROUND

Sodium ion batteries are similar to currently widely used lithium ion batteries in many aspects. Both are reusable secondary batteries including an anode (e.g., a negative electrode), a cathode (e.g., a positive electrode), and an electrolyte material; both can store energy; and both are charged and discharged via similar reaction mechanisms.

In contrast, sodium ion battery technologies are still in a relatively early stage, but are considered to be beneficial. Compared with lithium, sodium has more abundant reserves. However, in the related art, a positive electrode active material of a sodium battery has a low potential, and it is difficult for a polyanionic positive electrode material to achieve a theoretical capacity. For example, sodium ferric pyrophosphate (Na₄Fe₃(PO₄)₂P₂O₇) has a theoretical capacity of 129 mAh/g, but achieves only a level around 70 mAh/g in practice. The reasons may include low electronic conductivity of the corresponding positive electrode active material and slow ion migration of the corresponding positive electrode active material. Therefore, it is important to adjust the polyanionic positive electrode material to improve a capacity, a voltage, and rate performance of the material.

### SUMMARY

A first aspect of the present disclosure provides an electrode active material. The positive electrode active material has the following general formula: NaₓM_{y}(P_{1-w}A_{w}O₄)(P₂₋ᵤAᵤO₇). M includes one or more of Fe, Ti, V, Cr, Mn, Mg, Ca, Zr, Cd, Co, Ni, Cu, Zn, and Nb; A includes one or more of Ga, Ge, Sb, Se, Te, Bi, and In; x satisfies a condition of 2≤x≤4; y satisfies a condition of 1≤y≤4; z satisfies a condition of 0≤z≤2; w satisfies a condition of 0<w≤0.25; and u satisfies a condition of 0≤u≤0.2. u and z are not 0 at the same time.

A second aspect of the present disclosure provides a method of making a positive electrode active material, including: an M source material, an A source material, a sodium source, a phosphorus source, and a reducing agent are mixed to obtain a precursor solution; and the precursor solution is sintered to obtain the positive electrode active material. M includes one or more of Fe, Ti, V, Cr, Mn, Mg, Ca, Zr, Cd, Co, Ni, Cu, Zn, and Nb, and A includes one or more of Ga, Ge, Sb, Se, Te, Bi, and In.

A third aspect of the present disclosure provides a sodium ion battery. The sodium ion battery includes a positive electrode active material described in the first aspect or a positive electrode active material obtained using the method described in the second aspect.

A fourth aspect of the present disclosure provides an electrical device, which includes the sodium ion battery described in the third aspect.

### BRIEF DESCRIPTION OF DRAWINGS

FIG. 1A shows discharge voltage curves according to Comparative Example 1 and Examples 17-19;

FIG. 1B shows discharge voltage curves according to Comparative Example 1 and Examples 20-23;

FIG. 2 shows discharge voltage curves according to Comparative Example 2 and Examples 24-27;

FIG. 3 shows discharge voltage curves according to Comparative Example 3 and Examples 28 and 29;

FIG. 4 shows rate performance results according to Comparative Example 1 and Examples 17-20;

FIG. 5 shows rate performance results according to Comparative Example 2 and Examples 24-27;

FIG. 6 shows rate performance results according to Comparative Example 3 and Examples 28 and 29;

FIG. 7A is an XRD pattern of a positive electrode active material according to Example 1;

FIG. 7B is an XRD pattern of a positive electrode active material according to Example 24; and

FIG. 7C is an XRD pattern of a positive electrode active material according to Example 28.

### DETAILED DESCRIPTION

Endpoints of ranges and any values disclosed in this disclosure are not limited to the exact ranges or values. It should be understood that these ranges or values include values close to these ranges or values. For numerical ranges, endpoint values of ranges, endpoint values of ranges and individual point values, and individual point values can be combined with each other to obtain one or more new numerical ranges, and these numerical ranges are considered to be specifically disclosed in this disclosure.

Descriptions of terms in this disclosure are provided as examples only and are not intended to limit the scope of the disclosure.

The phrase “at least one of A, B, or C” is intended to include A, B, C, any combination of two or more of A, B, and C, or any combination of one or more of A, B, and C. The phrase “at least one of A and B” is intended to include A, B, or both A and B.

A first aspect of the present disclosure provides a positive electrode active material. The positive electrode active material has the following general formula: NaₓM_{y}(P_{w}A_{w}O₄)_{z}(P₂₋ᵤAᵤO₇). M includes one or more of Fe, Ti, V, Cr, Mn, Mg, Ca, Zr, Cd, Co, Ni, Cu, Zn, and Nb; A includes one or more of Ga, Ge, Sb, Se, Te, Bi, and In; x satisfies a condition of 2≤x≤4; y satisfies a condition of 1≤y≤4; z satisfies a condition of 0≤z≤2; w satisfies a condition of 0<w≤0.25; and u satisfies a condition of 0≤u≤0.2. u and z are not 0 at the same time. A molecular formula of the positive electrode active material may be determined according to an elemental quantitative analysis-ICP (inductively coupled plasma) method. An ICP-OES (inductively coupled plasma optical emission spectrometer) is used, and the molecular formula of the positive electrode active material may be obtained with reference to XRD (X-ray diffraction).

In the present disclosure, according to first principles, simulations show that an A-O distance is 1.7 to 2 Å, and an M-O distance is 1.95 to 2.25 Å in a unit cell of the positive electrode active material. Performance is adjusted through co-doping of materials (e.g., a transition metal) at position M and material (e.g., a metal) A at position P, increasing a volume of the unit cell and a bond length. This change can lower a Na ion diffusion barrier and improve an ionic conductivity.

In the present disclosure, the performance may be adjusted through co-doping of transition metal at position M and metal A at position P, which can make use of advantages of different elements and enhance performance of a polyanionic positive electrode material. For example, one or more of Ga, Ge, Sb, Se, Te, Bi, and In in metal A have a larger size than P. After one or more of Ga, Ge, Sb, Se, Te, Bi, and In in metal A are doped into the unit cell, the volume and the A-O distance change, and the A-O distance of the unit cell is 1.7 to 2 Å. Finally, it is found that the volume of the unit cell and the bond length increase. This change can lower a Na ion diffusion barrier and improve an ionic conductivity. In some aspects, doping of large-sized anions has the potential to improve electrochemical performance of the polyanionic material.

In some implementations of the present disclosure, the positive electrode active material in the present disclosure is a polyanionic compound. The polyanionic compound may be formed by connecting MO₆ octahedrons and PO₄ tetrahedrons through common points, common edges, and common surfaces to form a Na⁺ three-dimensional diffusion channel. A three-dimensional framework allows Na⁺ to have a relatively small volume change during intercalation/deintercalation, resulting in a large cycle number. First, metal A (Ga, Ge, Sb, Se, Te, Bi, or In) is doped into a polyanionic unit cell, with an A-O distance being 1.7 to 2 Å, and a P-O distance before doping being 1.5 to 1.62 Å. An increased volume of the unit cell leads to faster Na ion migration, thereby improving an actual capacity and rate performance. In addition, doping of Mn at position M increases a voltage, and doping of Ti improves an electronic conductivity.

In some implementations of the present disclosure, M includes one or more of Ti, Mn, Fe, Mg, and Ca, and A includes one or more of Ga, Bi, and Se. In some aspects, when M includes Mn, metal Mn improves voltage performance. In some aspects, when M includes Ti, metal Ti improves an electronic conductivity. In some aspects, when M includes Mg or Ca, cycle performance and processing performance can be improved.

In some implementations of the present disclosure, when M includes at least Fe and Mg, a molar ratio of Fe to Mg is 2.9-3:0.001-0.02; when M includes at least Fe and Ca, a molar ratio of Fe to Ca is 2.9-3:0.001-0.02; and A includes Ga or Se.

In some implementations of the present disclosure, in M, a molar ratio of Fe to Mg is 2.9-3:0.001-0.02, or a molar ratio of Fe to Ca is 2.9-3:0.001-0.02.

In some implementations of the present disclosure, the positive electrode active material has the following general formula: NaₓM_{y}(P_{1-w}A_{w}O₄)_{z}(P₂O₇), x=4, y=3, z=2, and 0<w≤0.25. The positive electrode active material within the above range is, for example, doped Na₄Fe₃(PO₄)₂P₂O₇.

In some implementations of the present disclosure, the positive electrode active material has the following general formula: NaₓM_{y}(P₂₋ᵤAᵤO₇), x=2, y=1, and 0≤u≤0.25. The positive electrode active material within the above range is, for example, doped Na₂FeP₂O₇.

In some implementations of the present disclosure, the positive electrode active material has the following general formula: NaₓM_{y}(P_{1-w}A_{w}O₄)_{z}(P₂O₇), x=3, y=2, z=1, and 0<w≤0.25. The positive electrode active material within the above range is, for example, doped Na₃Fe₂(PO₄)P₂O₇.

In some implementations of the present disclosure, performance of the positive electrode active material satisfies at least one of the following conditions: an electronic conductivity is 1×10⁻⁸ to 6×10⁻⁷ S/cm; a capacity retention ratio after 1200 cycles at 1 C is 82% to 97%; or a first-cycle discharge specific capacity at 0.1 C is 82 to 93 mAh/g.

A second aspect of the present disclosure provides a method of making a positive electrode active material, including:
An M source material, an A source material, a sodium source, a phosphorus source, and a reducing agent are mixed to obtain a precursor solution.

The precursor solution is sintered to obtain the positive electrode active material.

M includes one or more of Fe, Ti, V, Cr, Mn, Mg, Ca, Zr, Cd, Co, Ni, Cu, Zn, and Nb, and A includes one or more of Ga, Ge, Sb, Se, Te, Bi, and In.

In some implementations of the present disclosure, an M source material, an A source material, a sodium source, a phosphorus source, and a reducing agent are mixed and dissolved in water to obtain a precursor solution.

In some implementations of the present disclosure, the method includes granulating the precursor solution before sintering the precursor solution, where the granulating may be spray granulation.

In some implementations of the present disclosure, the M source material includes one or more of metal nitrate, metal oxalate, and metal citrate.

In some implementations of the present disclosure, the A source material includes one or more of metal nitrate, metal oxalate, and metal citrate.

In some implementations of the present disclosure, the sodium source includes one or more of sodium carbonate, sodium dihydrogen phosphate, sodium acetate, and sodium nitrate.

In some implementations of the present disclosure, the phosphorus source includes one or more of ammonium dihydrogen phosphate and etidronic acid.

In some implementations of the present disclosure, the reducing agent includes one or more of oxalic acid, citric acid, ascorbic acid, and tartaric acid. In addition to a reducing action, the reducing agent may also act as a carbon source and may stabilize metal ions; and may act as a chelating agent for combination with ferrous ions to form a chelate, thereby stabilizing metal M ions. In some aspects, in a final calcination process under an inert atmosphere, ascorbic acid forms in situ carbon that uniformly coats a surface of a material, improving an electrical conductivity of the material.

In some implementations of the present disclosure, a sintering temperature is 400 to 650° C. and a sintering time is 10 to 36 h.

In some implementations of the present disclosure, pre-sintering is further performed before the sintering, where a pre-sintering temperature is 260 to 330° C., and a pre-sintering time is 1 to 5 h.

In some implementations of the present disclosure, the pre-sintering is performed in a hydrogen-argon gas mixture, where a volume percent content of hydrogen in the hydrogen-argon gas mixture may be 1% to 10%.

In some implementations of the present disclosure, a molar ratio of the M source material, the A source material, the sodium source, the phosphorus source, and the reducing agent is (0.01-0.1):(0.0001-0.1):(0.01-0.1):(0.01-0.1):(0.01-0.1).

In the present disclosure, the composition and structure of the positive electrode active material may be determined through nuclear magnetic resonance, infrared spectroscopy, XRD, or elemental analysis, or the like, or determined through preparation and feeding.

A third aspect of the present disclosure provides a sodium ion battery. The sodium ion battery includes the positive electrode active material described above or a positive electrode active material obtained using the method described above.

A fourth aspect of the present disclosure provides an electrical device, which includes the sodium ion battery described above.

The present disclosure is described in further detail below by using examples.

The structural composition of the positive electrode active material in the examples of the present disclosure was determined according to an elemental quantitative analysis-ICP method. An appropriate amount of powder was taken, and dissolved in strong acid, and proportions of different elements were represented using an ICP-OES (inductively coupled plasma optical emission spectrometer). Finally, a molecular formula of the positive electrode active material was obtained with reference to XRD.

Unless otherwise specified in the following examples and comparative examples, normal conditions or conditions recommended by the manufacturer are used. The reagents or instruments used without a specified manufacturer may correspond to products that can be purchased from the market.

### Example 1

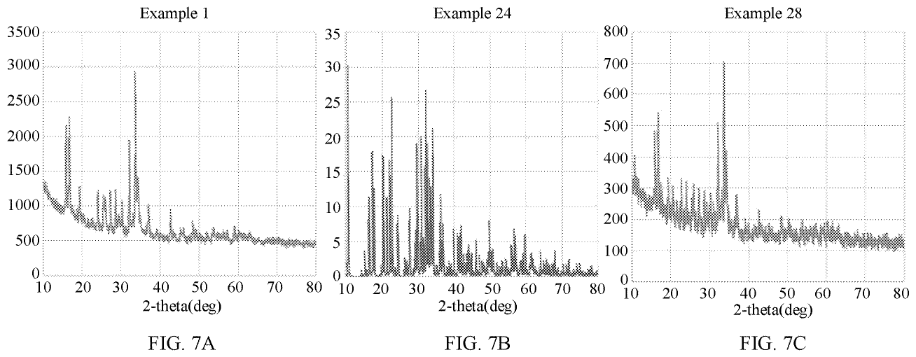

0.02978 mol of ferric nitrate, 0.0002 mol of zirconium nitrate, and 0.00002 mol of magnesium nitrate were dissolved in 600 mL of deionized water. Then, 0.10 mol of ascorbic acid was added, stirring was performed magnetically, and then 0.0399 mol of ammonium dihydrogen phosphate, 0.0001 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.978}Zr_{0.02}Mg_{0.002}(P_{0.995}Ga_{0.05}O₄)₂P₂O₇. XRD analysis was performed for Example 1, and an analysis result is shown in FIG. 7A.

### Example 2

0.02978 mol of ferric nitrate, 0.0002 mol of cadmium nitrate, and 0.00002 mol of magnesium nitrate were dissolved in 600 mL of deionized water. Then, 0.10 mol of ascorbic acid was added, stirring was performed magnetically, and then 0.0399 mol of ammonium dihydrogen phosphate, 0.0001 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.978} Cd_{0.02}Mg_{0.02}(P_{0.995}Ga_{0.05}O₄)₂P₂O₇.

### Example 3

0.02978 mol of ferric nitrate, 0.0002 mol of zirconium nitrate, and 0.00002 mol of magnesium nitrate were dissolved in 600 mL of deionized water. Then, 0.10 mol of ascorbic acid was added, stirring was performed magnetically, and then 0.0399 mol of ammonium dihydrogen phosphate, 0.0001 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.978} Cr_{0.02}Mg_{0.02}(P_{0.995}Ga_{0.05}O₄)₂P₂O₇.

### Example 4

0.0296 mol of ferric nitrate, 0.0002 mol of nickel nitrate, and 0.0002 mol of magnesium nitrate were dissolved in 600 mL of deionized water. Then, 0.10 mol of ascorbic acid was added, stirring was performed magnetically, and then 0.0399 mol of ammonium dihydrogen phosphate, 0.0001 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.960}Ni_{0.02}Mg_{0.02}(P_{0.995}Ga_{0.005}O₄)₂P₂O₇.

### Example 5

0.0296 mol of ferric nitrate, 0.0002 mol of zirconium nitrate, and 0.0002 mol of magnesium nitrate were dissolved in 600 mL of deionized water. Then, 0.10 mol of ascorbic acid was added, stirring was performed magnetically, and then 0.0399 mol of ammonium dihydrogen phosphate, 0.0001 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.960}Zr_{0.02}Mg_{0.02}(P_{0.995}Ga_{0.05}O₄)₂P₂O₇.

### Example 6

0.0296 mol of ferric nitrate, 0.0002 mol of manganese nitrate, and 0.0002 mol of magnesium nitrate were dissolved in 600 mL of deionized water. Then, 0.10 mol of ascorbic acid was added, stirring was performed magnetically, and then 0.0398 mol of ammonium dihydrogen phosphate, 0.0002 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.960}Mn_{0.02}Mg_{0.02}(P_{0.99}Ga_{0.01}O₄)₂P₂O₇.

### Example 7

0.0296 mol of ferric nitrate, 0.0002 mol of cadmium nitrate, and 0.0002 mol of calcium nitrate were dissolved in 600 mL of deionized water. Then, 0.10 mol of ascorbic acid was added, stirring was performed magnetically, and then 0.0398 mol of ammonium dihydrogen phosphate, 0.0002 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.960} Cd_{0.02} Ca_{0.02}(P_{0.99}Ga_{0.01}O₄)₂P₂O₇.

### Example 8

0.0296 mol of ferric nitrate, 0.0002 mol of manganese nitrate, and 0.0002 mol of calcium nitrate were dissolved in 600 mL of deionized water. Then, 0.10 mol of ascorbic acid was added, stirring was performed magnetically, and then 0.0398 mol of ammonium dihydrogen phosphate, 0.0002 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.960}Mn_{0.02} Ca_{0.02}(P_{0.99}Ga_{0.01}O₄)₂P₂O₇.

### Example 9

0.0296 mol of ferric nitrate, 0.0002 mol of copper nitrate, and 0.0002 mol of calcium nitrate were dissolved in 600 mL of deionized water. Then, 0.10 mol of ascorbic acid was added, stirring was performed magnetically, and then 0.0398 mol of ammonium dihydrogen phosphate, 0.0002 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.960} Cu_{0.02} Ca_{0.02}(P_{0.99}Ga_{0.01}O₄)₂P₂O₇.

### Example 10

0.0296 mol of ferric nitrate, 0.0002 mol of nickel nitrate, and 0.0002 mol of calcium nitrate were dissolved in 600 mL of deionized water. Then, 0.10 mol of ascorbic acid was added, stirring was performed magnetically, and then 0.0398 mol of ammonium dihydrogen phosphate, 0.0002 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.960}Ni_{0.02} Ca_{0.02}(P_{0.99}Ga_{0.01}O₄)₂P₂O₇.

### Example 11

0.0296 mol of ferric nitrate, 0.0002 mol of zinc nitrate, and 0.0002 mol of calcium nitrate were dissolved in 600 mL of deionized water. Then, 0.10 mol of ascorbic acid was added, stirring was performed magnetically, and then 0.0398 mol of ammonium dihydrogen phosphate, 0.0002 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.960}Zn_{0.02} Ca_{0.02}(P_{0.99}Ga_{0.01}O₄)₂P₂O₇.

### Example 12

0.02998 mol of ferric nitrate and 0.00002 mol of magnesium nitrate were dissolved in 600 mL of deionized water. Then, 0.10 mol of ascorbic acid was added, stirring was performed magnetically, and then 0.0399 mol of ammonium dihydrogen phosphate, 0.0001 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.998}Mg_{0.02}(P_{0.995}Ga_{0.05}O₄)₂P₂O₇.

### Example 13

0.02995 mol of ferric nitrate and 0.00005 mol of calcium nitrate were dissolved in 600 mL of deionized water. Then, 0.10 mol of ascorbic acid was added, stirring was performed magnetically, and then 0.0399 mol of ammonium dihydrogen phosphate, 0.0001 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.995} Ca_{0.05}(P_{0.995}Ga_{0.05}O₄)₂P₂O₇.

### Example 14

0.02998 mol of ferric nitrate and 0.00002 mol of magnesium nitrate were dissolved in 600 mL of deionized water. Then, 0.10 mol of ascorbic acid was added, stirring was performed magnetically, and then 0.0399 mol of ammonium dihydrogen phosphate, 0.0001 mol of germanate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.998}Mg_{0.02}(P_{0.995}Ge_{0.05}O₄)₂P₂O₇.

### Example 15

0.0298 mol of ferric nitrate and 0.0002 mol of cadmium nitrate were dissolved in 600 mL of deionized water. Then, 0.10 mol of ascorbic acid was added, stirring was performed magnetically, and then 0.0399 mol of ammonium dihydrogen phosphate, 0.0001 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.98} Cd_{0.02}(P_{0.995}Ga_{0.05}O₄)₂P₂O₇.

### Example 16

0.0298 mol of ferric nitrate and 0.0002 mol of cadmium nitrate were dissolved in 600 mL of deionized water. Then, 0.10 mol of ascorbic acid was added, stirring was performed magnetically, and then 0.0398 mol of ammonium dihydrogen phosphate, 0.0002 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{2.98} Cd_{0.02}(P_{0.99}Ga_{0.01}O₄)₂P₂O₇.

### Example 17

0.015 mol of ferric nitrate and 0.015 mol of manganese nitrate were dissolved in 600 mL of deionized water. Then, 0.10 mol of ascorbic acid was added, stirring was performed magnetically, and then 0.036 mol of ammonium dihydrogen phosphate, 0.004 mol of selenate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{1.5}Mn_{1.5}(P_{0.8}Se_{0.2}O₄)₂P₂O₇.

### Example 18

0.015 mol of ferric nitrate and 0.015 mol of manganese nitrate were dissolved in 600 mL of deionized water. Then, 0.10 mol of ascorbic acid was added, stirring was performed magnetically, and then 0.038 mol of ammonium dihydrogen phosphate, 0.002 mol of selenate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{1.5}Mn_{1.5}(P_{0.9}Se_{0.1}O₄)₂P₂O₇.

### Example 19

0.02 mol of ferric nitrate and 0.01 mol of manganese nitrate were dissolved in 600 mL of deionized water. Then, 0.10 mol of ascorbic acid was added, stirring was performed magnetically, and then 0.038 mol of ammonium dihydrogen phosphate, 0.002 mol of selenate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe₂Mn₁(P_{0.9}Se_{0.1}O₄)₂P₂O₇.

### Example 20

0.015 mol of ferric nitrate and 0.015 mol of manganese nitrate were dissolved in 600 mL of deionized water. Then, 0.10 mol of ascorbic acid was added, stirring was performed magnetically, and then 0.038 mol of ammonium dihydrogen phosphate, 0.002 mol of bismuthate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{1.5}Mn_{1.5}(P_{0.9}Bi_{0.1}O₄)₂P₂O₇.

### Example 21

0.015 mol of ferric nitrate and 0.015 mol of manganese nitrate were dissolved in 600 mL of deionized water. Then, 0.10 mol of ascorbic acid was added, stirring was performed magnetically, and then 0.038 mol of ammonium dihydrogen phosphate, 0.002 mol of gallate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{1.5}Mn_{1.5}(P_{0.9}Ga_{0.1}O₄)₂P₂O₇.

### Example 22

0.015 mol of ferric nitrate and 0.015 mol of titanium nitrate were dissolved in 600 mL of deionized water. Then, 0.10 mol of ascorbic acid was added, stirring was performed magnetically, and then 0.038 mol of ammonium dihydrogen phosphate, 0.002 mol of selenate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{1.5}Ti_{1.5}(P_{0.9}Se_{0.1}O₄)₂P₂O₇.

### Example 23

0.015 mol of ferric nitrate and 0.015 mol of titanium nitrate were dissolved in 600 mL of deionized water. Then, 0.10 mol of ascorbic acid was added, stirring was performed magnetically, and then 0.036 mol of ammonium dihydrogen phosphate, 0.004 mol of bismuthate, and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe_{1.5}Ti_{1.5}(P_{0.8}Bi_{0.2}O₄)₂P₂O₇.

### Example 24

0.02 mol of ferric nitrate nonahydrate and 0.02 mol of manganese nitrate were dissolved in 700 mL of deionized water. Then, 0.12 mol of ascorbic acid was added, stirring was performed magnetically, and then 0.076 mol of etidronic acid, 0.004 mol of selenate, and 0.08 mol of sodium nitrate were slowly added. After stirring for 1 h, a reaction solution was transferred to a spray dryer for spray granulation. Sprayed powder was pre-calcined for 4 h under a hydrogen-argon gas mixture (5%) at a temperature controlled at 300° C. Then, sintering was performed at 600° C. for 20 h to obtain carbon-encapsulated Na₂Fe_{0.5}Mn_{0.5}P_{1.9}Se_{0.1}O₇. XRD analysis was performed for Example 24, and an analysis result is shown in FIG. 7B.

### Example 25

0.02 mol of ferric nitrate nonahydrate and 0.02 mol of manganese nitrate were dissolved in 700 mL of deionized water. Then, 0.12 mol of ascorbic acid was added, stirring was performed magnetically, and then 0.076 mol of etidronic acid, 0.004 mol of bismuthate, and 0.08 mol of sodium nitrate were slowly added. After stirring for 1 h, a reaction solution was transferred to a spray dryer for spray granulation. Sprayed powder was pre-calcined for 4 h under a hydrogen-argon gas mixture (5%) at a temperature controlled at 300° C. Then, sintering was performed at 600° C. for 20 h to obtain carbon-encapsulated Na₂Fe_{0.5}Mn_{0.5}P_{1.9}Bi_{0.1}O₇.

### Example 26

0.02 mol of ferric nitrate nonahydrate and 0.02 mol of titanium nitrate were dissolved in 700 mL of deionized water. Then, 0.12 mol of ascorbic acid was added, stirring was performed magnetically, and then 0.076 mol of etidronic acid, 0.004 mol of selenate, and 0.08 mol of sodium nitrate were slowly added. After stirring for 1 h, a reaction solution was transferred to a spray dryer for spray granulation. Sprayed powder was pre-calcined for 4 h under a hydrogen-argon gas mixture (5%) at a temperature controlled at 300° C. Then, sintering was performed at 600° C. for 20 h to obtain carbon-encapsulated Na₂Fe_{0.5}Mn_{0.5}P_{1.9}Se_{0.1}O₇.

### Example 27

0.02 mol of ferric nitrate nonahydrate and 0.02 mol of manganese nitrate were dissolved in 700 mL of deionized water. Then, 0.12 mol of ascorbic acid was added, stirring was performed magnetically, and then 0.076 mol of etidronic acid, 0.004 mol of antimonate, and 0.08 mol of sodium nitrate were slowly added. After stirring for 1 h, a reaction solution was transferred to a spray dryer for spray granulation. Sprayed powder was pre-calcined for 4 h under a hydrogen-argon gas mixture (5%) at a temperature controlled at 300° C. Then, sintering was performed at 600° C. for 20 h to obtain carbon-encapsulated Na₂Fe_{0.5}Mn_{0.5}P_{1.9}Sb_{0.1}O₇.

### Example 28

0.02 mol of ferric nitrate nonahydrate and 0.02 mol of manganese nitrate were dissolved in 700 mL of deionized water. Then, 0.12 mol of ascorbic acid was added, stirring was performed magnetically, and then 0.058 mol of ammonium dihydrogen phosphate, 0.002 mol of selenate, and 0.06 mol of sodium carbonate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 550° C. for 20 h to obtain carbon-encapsulated Na₃FeMn(P_{0.9}Se_{0.1}O₄)P₂O₇. XRD analysis was performed for Example 28, and an analysis result is shown in FIG. 7C.

### Example 29

0.02 mol of ferric nitrate nonahydrate and 0.02 mol of titanium nitrate were dissolved in 700 mL of deionized water. Then, 0.12 mol of ascorbic acid was added, stirring was performed magnetically, and then 0.058 mol of ammonium dihydrogen phosphate, 0.002 mol of selenate, and 0.06 mol of sodium carbonate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 550° C. for 20 h to obtain carbon-encapsulated Na₃FeTi(P_{0.9}Se_{0.1}O₄)P₂O₇.

### Comparative Example 1

0.03 mol of ferric nitrate nonahydrate was dissolved in 600 mL of deionized water. Then, 0.10 mol of ascorbic acid was added, stirring was performed magnetically, and then 0.04 mol of ammonium dihydrogen phosphate and 0.04 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 500° C. for 36 h to obtain carbon-encapsulated Na₄Fe₃(PO₄)₂P₂O₇.

### Comparative Example 2

0.04 mol of ferric nitrate nonahydrate was dissolved in 700 mL of deionized water. Then, 0.12 mol of ascorbic acid was added, stirring was performed magnetically, and then 0.08 mol of ammonium dihydrogen phosphate and 0.08 mol of sodium acetate were slowly added. After stirring for 1 h, a reaction solution was transferred to a spray dryer for spray granulation. Sprayed powder was pre-calcined for 4 h under a hydrogen-argon gas mixture (5%) at a temperature controlled at 300° C. Then, sintering was performed at 600° C. for 20 h to obtain carbon-encapsulated Na₂FeP₂O₇.

### Comparative Example 3

0.04 mol of ferric nitrate nonahydrate was dissolved in 700 mL of deionized water. Then, 0.12 mol of ascorbic acid was added, stirring was performed magnetically, and then 0.08 mol of ammonium dihydrogen phosphate and 0.06 mol of sodium acetate were slowly added. After stirring for 1 h, a reaction solution was transferred to a spray dryer for spray granulation. Sprayed powder was pre-calcined for 2 h under a hydrogen-argon gas mixture (5%) at a temperature controlled at 300° C. Then, sintering was performed at 550° C. for 20 h to obtain carbon-encapsulated Na₃Fe₂(PO₄)P₂O₇.

### Test Example 1: Electronic Conductivities, 1200-Cycle Capacity Retention Ratios, and First-Cycle Discharge Specific Capacities at 0.1 C were Measured for Positive Electrode Active Materials Obtained in the Examples and the Comparative Examples

Electronic conductivity: The positive electrode active material was measured using a direct current four probe method.

1200-cycle capacity retention ratio: The positive electrode active materials obtained in the examples and the comparative examples were applied to sodium ion batteries. After capacity measurement through charging and discharging at 0.2 C, a discharge capacity was used as a rated capacity. A voltage range was 2 to 3.4 V. 1 C cycling was used, with each step resting for 10 minutes. A constant-current and constant-voltage mode was used for charging, a cutoff current was 0.05 C, and a constant-current mode was used for charging.

First-cycle discharge specific capacity at 0.1 C: Small soft packages were made through hand-folding, were charged at a rate of 0.1 C to 3.5 V for formation, and after aging for two days, were discharged at 0.0 C to 2 V for capacity grading.

Test results are shown in Table 1.

TABLE 1

| | | | First-cycle | |
|---|---|---|---|---|
| | | | discharge | 1200- |
| | | | specific | cycle |
| | | Electronic | capacity at | capacity |
| | Structural formula of a positive electrode | conductivity | 0.1 C | retention |
| Number | material of a battery | (S/cm) | (mAh/g) | ratio |
| Example 1 | Na₄Fe_{2.978}Zr_{0.02}Mg_{0.002}(P_{0.995}Ga_{0.005}O₄)₂P₂O₇ | 1.56 × 10⁻⁷ | 89.83 | 95.55% |
| Example 2 | Na₄Fe_{2.978}Cd_{0.02}Mg_{0.002}(P_{0.995}Ga_{0.005}O₄)₂P₂O₇ | 1.95 × 10⁻⁷ | 90.56 | 92.09% |
| Example 3 | Na₄Fe_{2.978}Cr_{0.02}Mg_{0.002}(P_{0.995}Ga_{0.005}O₄)₂P₂O₇ | 2.65 × 10⁻⁷ | 91.23 | 93.68% |
| Example 4 | Na₄Fe_{2.960}Ni_{0.02}Mg_{0.02}(P_{0.995}Ga_{0.005}O₄)₂P₂O₇ | 1.08 × 10⁻⁷ | 89.93 | 92.95% |
| Example 5 | Na₄Fe_{2.960}Zr_{0.02}Mg_{0.02}(P_{0.995}Ga_{0.005}O₄)₂P₂O₇ | 9.32 × 10⁻⁸ | 87.45 | 94.38% |
| Example 6 | Na₄Fe_{2.960}Mn_{0.02}Mg_{0.02}(P_{0.99}Ga_{0.01}O₄)₂P₂O₇ | 5.17 × 10⁻⁸ | 89.44 | 93.82% |
| Example 7 | Na₄Fe_{2.960}Cd_{0.02}Ca_{0.02}(P_{0.99}Ga_{0.01}O₄)₂P₂O₇ | 9.32 × 10⁻⁷ | 88.38 | 92.75% |
| Example 8 | Na₄Fe_{2.960}Mn_{0.02}Ca_{0.02}(P_{0.99}Ga_{0.01}O₄)₂P₂O₇ | 8.87 × 10⁻⁸ | 91.83 | 93.51% |
| Example 9 | Na₄Fe_{2.960}Cu_{0.02}Ca_{0.02}(P_{0.99}Ga_{0.01}O₄)₂P₂O₇ | 9.83 × 10⁻⁸ | 90.14 | 90.65% |
| Example 10 | Na₄Fe_{2.960}Ni_{0.02}Ca_{0.02}(P_{0.99}Ga_{0.01}O₄)₂P₂O₇ | 6.84 × 10⁻⁸ | 89.56 | 91.67% |
| Example 11 | Na₄Fe_{2.960}Zn_{0.02}Ca_{0.02}(P_{0.99}Ga_{0.01}O₄)₂P₂O₇ | 1.87 × 10⁻⁷ | 90.19 | 90.82% |
| Example 12 | Na₄Fe_{2.998}Mg_{0.002}(P_{0.995}Ga_{0.005}O₄)₂P₂O₇ | 4.61 × 10⁻⁷ | 87.22 | 93.67% |
| Example 13 | Na₄Fe_{2.995}Ca_{0.005}(P_{0.995}Ga_{0.005}O₄)₂P₂O₇ | 9.91 × 10⁻⁸ | 84.95 | 94.22% |
| Example 14 | Na₄Fe_{2.998}Mg_{0.002}(P_{0.995}Se_{0.005}O₄)₂P₂O₇ | 9.87 × 10⁻⁸ | 86.91 | 92.90% |
| Example 15 | Na₄Fe_{2.98}Cd_{0.02}(P_{0.995}Ga_{0.005}O₄)₂P₂O₇ | 6.95 × 10⁻⁸ | 87.91 | 88.69% |
| Example 16 | Na₄Fe_{2.98}Cd_{0.02}(P_{0.99}Ga_{0.01}O₄)₂P₂O₇ | 8.95 × 10⁻⁸ | 86.76 | 87.93% |
| Example 17 | Na₄Fe_{1.5}Mn_{1.5}(P_{0.8}Se_{0.2}O₄)₂P₂O₇ | 6.76 × 10⁻⁸ | 83.22 | 81.92% |
| Example 18 | Na₄Fe_{1.5}Mn_{1.5}(P_{0.9}Se_{0.1}O₄)₂P₂O₇ | 9.91 × 10⁻⁸ | 86.95 | 87.53% |
| Example 19 | Na₄Fe₂Mn₁(P_{0.9}Se_{0.1}O₄)₂P₂O₇ | 6.87 × 10⁻⁸ | 84.91 | 83.45% |
| Example 20 | Na₄Fe_{1.5}Mn_{1.5}(P_{0.9}Bi_{0.1}O₄)₂P₂O₇ | 4.16 × 10⁻⁸ | 83.92 | 83.32% |
| Example 21 | Na₄Fe_{1.5}Mn_{1.5}(P_{0.9}Ga_{0.1}O₄)₂P₂O₇ | 5.58 × 10⁻⁸ | 85.99 | 89.92% |
| Example 22 | Na₄Fe_{1.5}Ti_{1.5}(P_{0.9}Se_{0.1}O₄)₂P₂O₇ | 10.56 × 10⁻⁸ | 86.75 | 88.78% |
| Example 23 | Na₄Fe_{1.5}Ti_{1.5}(P_{0.8}Bi_{0.2}O₄)₂P₂O₇ | 6.45 × 10⁻⁸ | 83.11 | 83.19% |
| Example 24 | Na₂Fe_{0.5}Mn_{0.5}P_{1.9}Se_{0.1}O₇ | 1.56 × 10⁻⁸ | 88.91 | 87.14% |
| Example 25 | Na₂Fe_{0.5}Mn_{0.5}P_{1.9}Bi_{0.1}O₇ | 0.88 × 10⁻⁸ | 86.08 | 85.61% |
| Example 26 | Na₂Fe_{0.5}Ti_{0.5}P_{1.9}Se_{0.1}O₇ | 4.98 × 10⁻⁸ | 86.11 | 92.42% |
| Example 27 | Na₂Fe_{0.5}Mn_{0.5}P_{1.9}Sb_{0.1}O₇ | 2.12 × 10⁻⁸ | 82.25 | 82.05% |
| Example 28 | Na₃FeMn(P_{0.9}Se_{0.1}O₄)P₂O₇ | 7.45 × 10⁻⁸ | 64.14 | 86.05% |
| Example 29 | Na₃FeTi(P_{0.9}Se_{0.1}O₄)P₂O₇ | 11.69 × 10⁻⁹ | 61.00 | 86.14% |
| Comparative | Na₄Fe₃(PO₄)₂P₂O₇ | 2.17 × 10⁻⁹ | 72.84 | 77.59% |
| Example 1 | | | | |
| Comparative | Na₂FeP₂O₇ | 3.88 × 10⁻⁹ | 77.63 | 74.85% |
| Example 2 | | | | |
| Comparative | Na₃Fe₂(PO₄)P₂O₇ | 9.80 × 10⁻⁹ | 53.81 | 66.98% |
| Example 3 | | | | |

From the results in Table 1, for doping of the Na₄Fe₃(PO₄)₂P₂O₇ active material, through comparison between Examples 1 to 23 and Comparative Example 1, performance may be adjusted through co-doping of metal M and metal A, double doping of anions and cations may have an effect on cycle improvement, and effects of Examples 1 to 23 may be better than that of Comparative Example 1. For the doping element M, Mg and Ca were superior to other elements, improving the electronic conductivity, as shown by the results in Examples 1 to 11 and Examples 12 to 23. In some aspects, comparison between Example 2 and Example 15 shows that double doping of cations of Mg and other elements leads to a better electronic conductivity, 1200-cycle capacity retention ratio, and first-cycle discharge specific capacity at 0.1 C. Comparison between Example 7 and Example 16 shows that double doping of cations of Ca and other elements leads to a better electronic conductivity, 1200-cycle capacity retention ratio, and first-cycle discharge specific capacity at 0.1 C.

For doping of the Na₂FeP₂O₇ active material, through comparison between Examples 24 to 27 and Comparative Example 2, performance may be adjusted through co-doping of metal M and metal A, and effects of Examples 24 to 27 may be better than that of Comparative Example 2.

For doping of the Na₃Fe₂(PO₄)P₂O₇ active material, through comparison between Examples 28 and 29 and Comparative Example 3, performance may be adjusted through co-doping of metal M and metal A, and effects of Examples 28 and 29 may be better than that of Comparative Example 3.

### Test Example 2: Discharge Voltage and Rate Performance Tests for the Examples and the Comparative Examples

Discharge voltage: A slurry may be prepared by mixing positive electrode powder, a conductive agent, and a binder at a ratio of 100:4:2, coated on carbon-coated aluminum foil, baked, and then rolled into an electrode sheet, which may be compacted to 1.9 g/cc. The electrode sheet may be cut, weighed, and baked in vacuum at 120 degrees Celsius for one day to prepare a coin half-cell. A negative electrode may be a hand-pressed sodium tablet. Electrochemical performance of a positive electrode material may be evaluated, to obtain discharge voltage curves of different positive electrode materials.

Rate performance: 0.2 C may be uniformly used for charging, and a discharge rate may be set to 0.1 C/0.2 C/0.5 C/10 C, with 5 cycles at each rate. Discharging at different rates can reflect an ion diffusion capability of a positive electrode material.

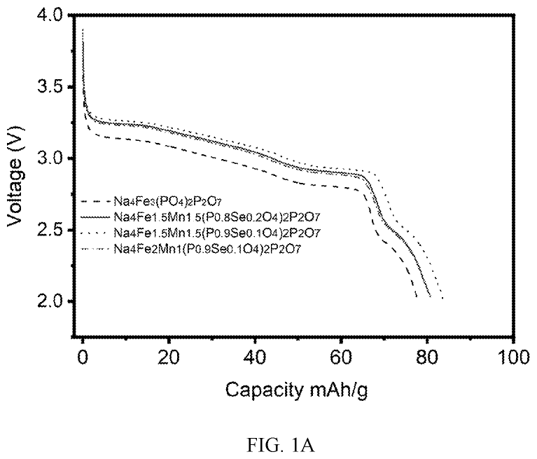

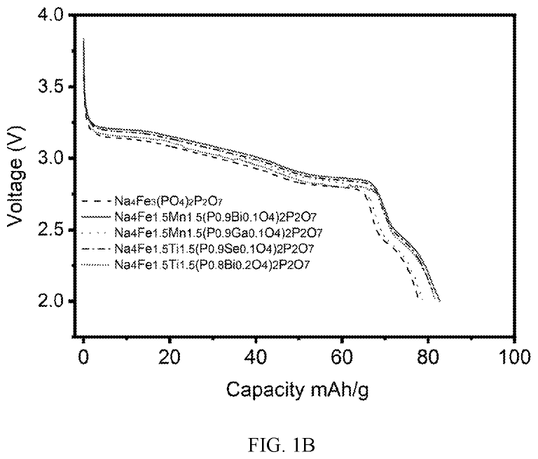

FIG. 1A and FIG. 1B show discharge voltage curves according to Comparative Example 1 and Examples 17 to 23. Some performance corresponding to a positive electrode active material obtained through double doping of Mn/Ti and Se/Bi/Ga is enhanced. For example, cycle performance, a voltage, and a capacity are improved. (Mn reduces the electronic conductivity, and Ti increases the electronic conductivity, which applies to the following two types of materials).

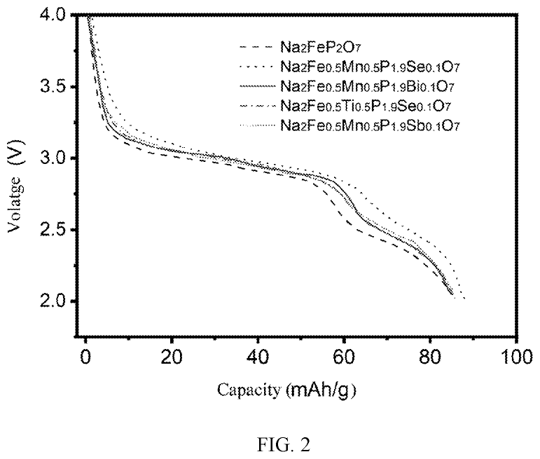

FIG. 2 shows discharge voltage curves according to Comparative Example 2 and Examples 24 to 27. Double doping of Mn/Ti and Bi/Se/Sb improves a discharge voltage, a capacity, and cycle performance of a positive electrode active material.

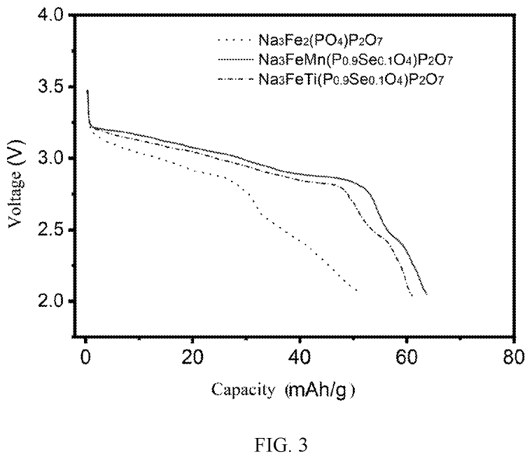

FIG. 3 shows discharge voltage curves according to Comparative Example 3 and Examples 28 and 29. Double doping of Mn/Ti and Se improves a discharge voltage, a capacity, and cycle performance of a positive electrode active material.

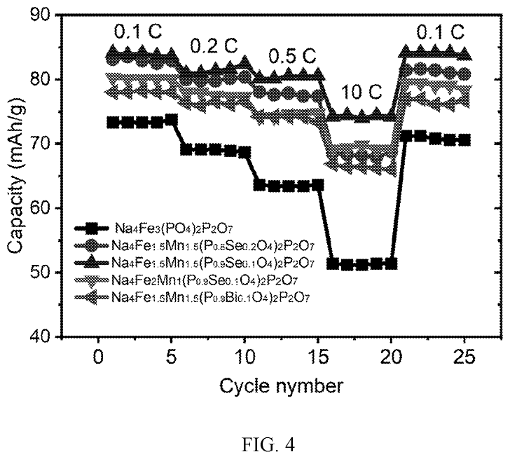

FIG. 4 shows rate performance results according to Comparative Example 1 and Examples 17, 18, 19, and 20. At 0.1 C/0.2 C/0.5 C/10 C, double doping improves rate performance of a positive electrode active material. This is because large-sized Mn/Ti/Se/Ga expands an ion channel and lowers a sodium ion diffusion barrier.

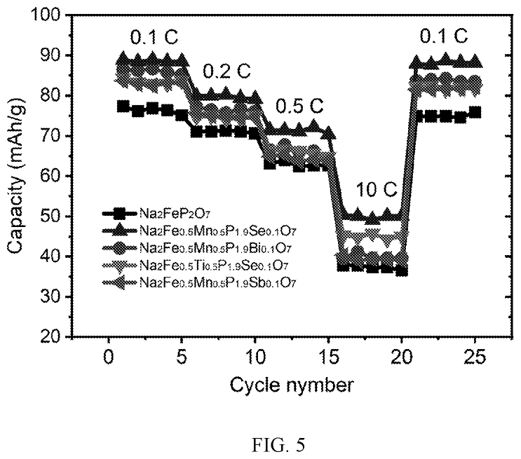

FIG. 5 shows rate performance results according to Comparative Example 2 and Examples 24, 25, 26, and 27. At 0.1 C/0.2 C/0.5 C/10 C, double doping improves rate performance of a positive electrode active material.

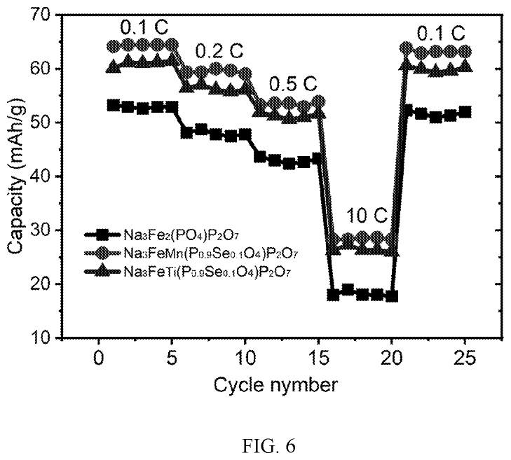

FIG. 6 shows rate performance results according to Comparative Example 3 and Examples 28 and 29. At 0.1 C/0.2 C/0.5 C/10 C, double doping improves rate performance of a positive electrode active material.

FIG. 7A, FIG. 7B, and FIG. 7C are XRD patterns of positive electrode active materials according to Example 1, Example 24, and Example 28 of the present disclosure, respectively. Molecular formulas in the corresponding examples can be obtained from main peak positions and lattice parameters of the materials obtained in Examples 1, 24, and 28 in combination with element ratio analysis of ICP. A phase purity of the material after sintering may be high.

Non-limiting examples of the present disclosure are described above, but the present disclosure is not limited thereto. Within the scope of the present disclosure, a plurality of modifications may be made to the technical solutions of the present disclosure, including combinations of technical features in any other appropriate manner. These modifications and combinations should also be considered as content disclosed in the present disclosure and fall within the scope of the present disclosure.

1. A positive electrode active material, having the following general formula: NaₓM_{y}(P_{1-w}A_{w}O₄)_{z}(P₂₋ᵤAᵤO₇), wherein
M includes one or more of Fe, Ti, V, Cr, Mn, Mg, Ca, Zr, Cd, Co, Ni, Cu, Zn, and Nb;
A includes one or more of Ga, Ge, Sb, Se, Te, Bi, and In;
x satisfies a condition of 2≤x≤4;
y satisfies a condition of 1≤y≤4;
z satisfies a condition of 0≤z≤2;
w satisfies a condition of 0<w≤0.25;
u satisfies a condition of 0≤u≤0.2; and
u and z are not 0 at the same time.

2. The positive electrode active material according to claim 1, wherein
M includes one or more of Ti, Mn, Fe, Mg, and Ca; and
A includes one or more of Ga, Bi, and Se.

3. The positive electrode active material according to claim 1, wherein
when M includes at least Fe and Mg, a molar ratio of Fe to Mg is 2.9-3:0.001-0.02;
when M includes at least Fe and Ca, a molar ratio of Fe to Ca is 2.9-3:0.001-0.02; and
A includes Ga or Se.

4. The positive electrode active material according to claim 1, wherein
the positive electrode active material has the following general formula: NaₓM_{y}(P_{1-w}A_{w}O₄)_{z}(P₂O₇), x=4, y=3, z=2, and 0<w≤0.25;
the positive electrode active material has the following general formula: Na_{X}M_{y}(P₂₋ᵤAᵤO₇), x=2, y=1, and 0≤u≤0.2; or
the positive electrode active material has the following general formula: NaₓM_{y}(P_{1-w}A_{w}O₄)_{z}(P₂O₇), x=3, y=2, z=1, and 0<w≤0.25.

5. The positive electrode active material according to claim 1, wherein performance of the positive electrode active material satisfies at least one of:
an electronic conductivity is 1×10⁻⁸ to 6×10⁻⁷ S/cm;
a capacity retention ratio after 1200 cycles at 1 C is 82% to 97%; or
a first-cycle discharge specific capacity at 0.1 C is 82 to 93 mAh/g.

6. A method of making a positive electrode active material, comprising:
mixing an M source material, an A source material, a sodium source, a phosphorus source, and a reducing agent to obtain a precursor solution; and
sintering the precursor solution to obtain the positive electrode active material, wherein
M includes one or more of Fe, Ti, V, Cr, Mn, Mg, Ca, Zr, Cd, Co, Ni, Cu, Zn, and Nb; and
A includes one or more of Ga, Ge, Sb, Se, Te, Bi, and In.

7. The method according to claim 6, further comprising:
granulating the precursor solution before the sintering the precursor solution, wherein
the M source material includes one or more of metal nitrate, metal oxalate, and metal citrate;
the A source material includes one or more of metal nitrate, metal oxalate, and metal citrate;
the sodium source includes one or more of sodium carbonate, sodium dihydrogen phosphate, sodium acetate, and sodium nitrate;
the phosphorus source includes one or more of ammonium dihydrogen phosphate and etidronic acid; and
the reducing agent includes one or more of oxalic acid, citric acid, ascorbic acid, and tartaric acid.

8. The method according to claim 6, wherein a sintering temperature is 400 to 650° C. and a sintering time is 10 to 36 h.

9. The method according to claim 6, further comprising:
performing pre-sintering before the sintering, wherein a pre-sintering temperature is 260 to 330° C., and a pre-sintering time is 1 to 5 h.

10. The method according to claim 6, wherein
a molar ratio of the M source material, the A source material, the sodium source, the phosphorus source, and the reducing agent is (0.01-0.1):(0.0001-0.1):(0.01-0.1):(0.01-0.1):(0.01-0.1).

11. A sodium ion battery, comprising:
a positive electrode active material, having the following general formula: NaₓM_{y}(P_{1-w}A_{w}O₄)_{z}(P₂₋ᵤAᵤO₇), wherein
M includes one or more of Fe, Ti, V, Cr, Mn, Mg, Ca, Zr, Cd, Co, Ni, Cu, Zn, and Nb;
A includes one or more of Ga, Ge, Sb, Se, Te, Bi, and In;
x satisfies a condition of 2≤x≤4;
y satisfies a condition of 1≤y≤4;
z satisfies a condition of 0≤z≤2;
w satisfies a condition of 0<w≤0.25;
u satisfies a condition of 0≤u≤0.2; and
u and z are not 0 at the same time.

12. The sodium ion battery according to claim 11, wherein
M includes one or more of Ti, Mn, Fe, Mg, and Ca; and
A includes one or more of Ga, Bi, and Se.

13. The sodium ion battery according to claim 11, wherein
when M includes at least Fe and Mg, a molar ratio of Fe to Mg is 2.9-3:0.001-0.02;
when M includes at least Fe and Ca, a molar ratio of Fe to Ca is 2.9-3:0.001-0.02; and
A includes Ga or Se.

14. The sodium ion battery according to claim 11, wherein
the positive electrode active material has the following general formula: NaₓM_{y}(P_{1-w}A_{w}O₄)_{z}(P₂O₇), x=4, y=3, z=2, and 0<w≤0.25;
the positive electrode active material has the following general formula: Na_{X}M_{y}(P₂₋ᵤAᵤO₇), wherein x=2, y=1, and 0≤u≤0.2; or
the positive electrode active material has the following general formula: NaₓM_{y}(P_{1-w}A_{w}O₄)_{z}(P₂O₇), x=3, y=2, z=1, and 0<w≤0.25.

15. The sodium ion battery according to claim 11, wherein performance of the positive electrode active material satisfies at least one of:
an electronic conductivity is 1×10⁻⁸ to 6×10⁻⁷ S/cm;
a capacity retention ratio after 1200 cycles at 1 C is 82% to 97%; or
a first-cycle discharge specific capacity at 0.1 C is 82 to 93 mAh/g.
